(19) United States
(12) Patent Application Publication
(10) Pub. No.: US 2006/0003074 A1
(43) Pub. Date: Jan. 5, 2006

(54) Tasteful chocolate and caramel milk drink

(76) Inventor: David B. Carpenter, Landisville, PA (US)

Correspondence Address: THE INVENTORS NETWORK, INC., 332 ACADEMY STREET, CARNEGIE, PA, 15106, US

(21) Appl. No.: 10/880,481

(22) Filed: Jul. 1, 2004

(51) Int. Cl. A23L 1/30

(52) U.S. Cl. 426/584

(57) ABSTRACT

A tasteful milk drink includes mixing together in specific proportions chocolate syrup and caramel syrup until they are blended together, and then adding thereto milk, preferably 2% milk, and continuing with the stirring and mixing until the chocolate syrup and the caramel syrup are thoroughly diluted and dispersed throughout the milk, whereupon the flavored milk drink is ready for consumption by children and adults.

### FIELD OF THE INVENTION

The present invention pertains to tasteful drinks, and more particularly pertains to a chocolate and caramel milk drink that is easy to make and enjoyable to consume.

### BACKGROUND OF THE INVENTION

The shelves and cases of a typical food and produce store disclose an enormous range of drinks and beverages that run the gamut from soda drinks to milk and diary-type drinks to citrus and juice drinks and beverages. Additionally, the steps and processes for manufacturing such drinks and beverages can involve complicated chemistry and industrial techniques. One long-time favorite flavored milk drink for young and old is chocolate milk. However, experimentation for producing different types of milk drinks is common given the range of flavorings, in both liquid and semi-liquid forms, which are available. This allows the individual to experiment and conceive his or her own milk-flavored drink. The prior art discloses a number of processes for producing novel drinks and confections, albeit of a fairly sophisticated nature.

For example, the Keller et al. patent (U.S. Pat. No. 5,130,149) discloses a novel coffee flavorant manufacturing process that includes processing soya meal at variable temperatures and then isolating the product by various techniques to produce the flavorant.

The Ter Braak patent (U.S. Pat. No. 5,962,061) discloses a process for producing a confectionary mass from components that include milk proteins, sugar, glucose, fat and water processed through a closed tank, an evaporation chamber, and a closed chamber.

The Tucker et al. patents (U.S. Pat. Nos. 6,099,874 and 6,491,958 B1) disclose a frozen novelty and process of manufacturing that includes an edible core mounted on a stick and covered by several layers of edible material.

The Bonnasse-Gahot et al. patent (U.S. Pat. No. 6,312,750 B1) discloses a sweet snack that includes a mixture of skimmed milk powder, bisodium phosphate, wheat flour, crystal sugar, butter oil and water in varying proportions.

Nonetheless, there remains a need for a tasteful milk drink that is easy to make from store-bought products.

### SUMMARY OF THE INVENTION

The present invention comprehends a tasteful milk drink that includes mixing chocolate syrup and caramel syrup in specific amounts, and then adding a given quantity of milk, preferably 2% milk, then stirring and shaking all of the ingredients until the caramel syrup and the chocolate syrup are distributed throughout the milk and no longer discernible at the bottom or along the sides of the drinking glass. The drink is now a tasteful milk drink that can be pleasantly and enjoyably consumed by both children and adults.

It is an objective of the present invention to create a chocolate-flavored milk drink that can be easily and quickly made by an individual in his or her own home.

It is another objective of the present invention to provide the individual with the ingredients and steps for creating a healthy, enjoyable, tasty milk drink.

It is still yet another objective of the present invention to provide the individual with the ability to make a tasty, healthy milk drink from ingredients available at any convenience or grocery store.

A still yet further objective of the present invention is to provide a tasty, healthy milk drink that especially appeals to connoisseurs of chocolate products in both dairy and non-dairy form.

Still a further objective of the present invention is to provide a tasty, healthy chocolate-caramel milk drink that is available to consumers at highway rest stops, restaurants, convenience stores, grocery stores, and gas stations.

These and other objects, features and advantages will become apparent to one skilled in the art upon a perusal of the following detailed description read in conjunction with the accompanying drawing figures.

### BRIEF DESCRIPTION OF THE DRAWINGS

FIG. 1 is a perspective view of the containers for the ingredients for making the tasteful milk drink of the present invention;

FIG. 2 is a plan view of the recipe of ingredients for making the tasteful milk drink of the present invention;

FIG. 3 is a plan view of the steps for mixing the ingredients that comprise the tasteful milk drink of the present invention; and

FIG. 4 is a perspective view of a standard drinking glass into which the individual can pour the tasteful milk drink of the present invention for consumption.

### DETAILED DESCRIPTION OF THE PREFERRED EMBODIMENT

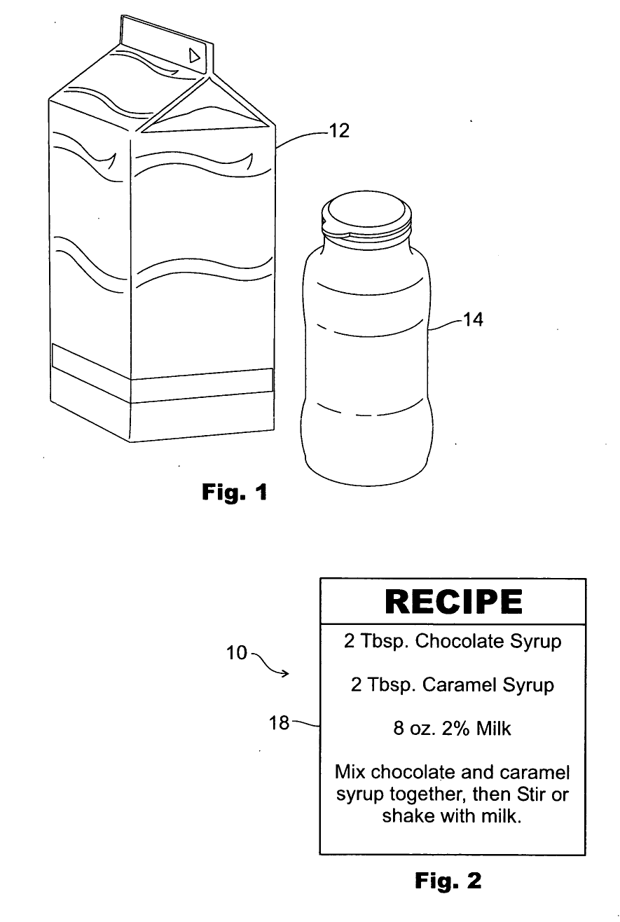

Illustrated in FIGS. 1-4 flavored milk drink 10 that is tasty, healthy, easy to make and enjoyable for individuals of all ages from children to adults. The ingredients for the milk drink 10 are readily available at convenience stores and grocery stores, and the steps for mixing and making the milk drink 10 are simple and straightforward and can be accomplished in one's kitchen. The milk drink 10 can be enjoyed by all individuals, and is especially enjoyable for connoisseurs of chocolate products.

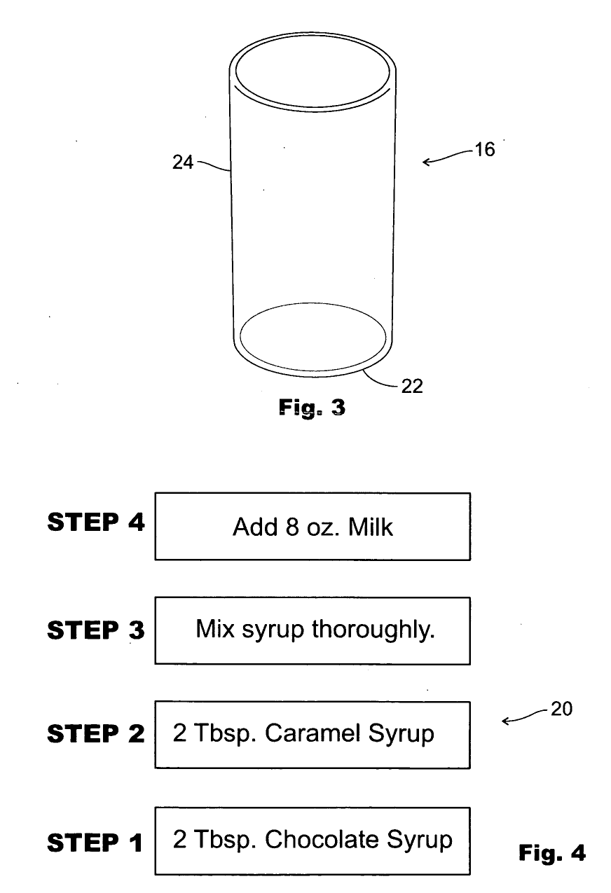

Shown in FIG. 1 is a milk container 12 for the one of the ingredients—milk that preferably is two percent milk. Also shown in FIG. 1 is the container 14 for another of the ingredients—the container for the chocolate syrup. The third ingredient is caramel syrup, which is available in various sizes of plastic and glass jar containers. The ingredients are mixed in a standard drinking glass, such as the 12 ounce drinking glass 16 shown in FIG. 3.

Thus, as shown in FIG. 2, a recipe 18 for the preferred embodiment of the flavored milk drink 10 includes using two tablespoons of the chocolate syrup and two tablespoons of the caramel syrup that are stirred and shaken together for thorough intermixing with the milk.

More specifically, one preferred sequence of steps 20 for creating the delightful flavored milk drink 10 of the present invention is shown in FIG. 4. The steps 20 include providing the drinking glass 16 as the container or receptacle wherein the ingredients are mixed. Next, two tablespoons of the chocolate syrup are added to the drinking glass 16. The chocolate syrup and the caramel syrup are then vigorously stirred until they blend together. The next step is to add eight ounces of milk from the milk container 12, preferably two percent milk, to the caramel syrup and the chocolate syrup. The milk, the caramel syrup and the chocolate syrup are then stirred and mixed together until the caramel syrup and the chocolate syrup are not discernible along the bottom 22 of the glass 16 or along the sidewall 24 of the glass 16. When this condition is obtained, the caramel syrup and the chocolate syrup are sufficiently intermixed and dispersed throughout the milk. The flavored chocolate and caramel milk drink 10 is now ready for consumption.

While the invention has been illustrated and described in detail in the drawings and the foregoing description, it is understood that numerous modifications, alterations, and variations can be made without departing from the spirit and scope of the invention as set forth in the appended claims.

I claim:

1. A chocolate-flavored milk drink, comprising:
two tablespoons of chocolate syrup;
two tablespoons of caramel syrup intermixed with the two tablespoons of chocolate syrup; and
eight ounces of pasteurized milk intermixed with the chocolate syrup and the caramel syrup so that the caramel syrup and the chocolate syrup are dispersed throughout the pasteurized milk thereby making the milk drink ready for consumption.

2. The chocolate-flavored milk drink of claim 1 wherein the milk is two percent milk.

3. A chocolate and caramel flavored milk drink that comprises the steps of:
providing a 12 ounce drinking glass for ingredient mixing;
placing two tablespoons of chocolate syrup in the drinking glass;
placing two tablespoons of caramel syrup in the drinking glass;
stirring the chocolate syrup and the caramel syrup until they are intermixed;
adding eight ounces of pasteurized milk to the drinking glass; and
stirring the milk with the caramel syrup and the chocolate syrup until the caramel syrup and the chocolate syrup are thoroughly dispersed throughout the milk whereupon the flavored milk drink is ready for consumption.

4. The chocolate and caramel flavored milk drink of claim 3 wherein the milk is two percent milk.

5. A chocolate and caramel flavored milk drink that comprises the steps of:
providing a 12-ounce drinking glass as the mixing container;
placing two tablespoons of caramel syrup in the drinking glass;
placing two tablespoons of chocolate syrup in the drinking glass;
stirring together the caramel syrup and the chocolate syrup until they are intermixed;
adding eight ounces of milk to the drinking glass; and
stirring the caramel syrup and the chocolate syrup in the milk until the caramel syrup and the chocolate syrup are thoroughly dispersed throughout the milk whereupon the milk drink is ready for consumption.
